(19) United States
(12) Patent Application Publication
(10) Pub. No.: US 2013/0042825 A1
(43) Pub. Date: Feb. 21, 2013

(54) LUBRICATION SYSTEM OF AN INTERNAL COMBUSTION ENGINE

(71) Applicants: Yuichi Shimasaki, Mishima-shi (JP); Yoshinori Futonagane, Susono-shi (JP); Takuya Hirai, Susono-shi (JP)

(72) Inventors: Yuichi Shimasaki, Mishima-shi (JP); Yoshinori Futonagane, Susono-shi (JP); Takuya Hirai, Susono-shi (JP)

(73) Assignee: TOYOTA JIDOSHA KABUSHIKI KAISHA, Toyota-shi, Aichi (JP)

(21) Appl. No.: 13/509,171

(22) PCT Filed: Nov. 13, 2009
(86) PCT No.: PCT/JP09/69381

§ 371 Date: May 10, 2012

(51) Int. Cl. F02B 63/04

(52) U.S. Cl. 123/2

(57) ABSTRACT

The present invention is intended to reduce the friction of an internal combustion engine in a suitable manner when the internal combustion engine is in a cold state, thereby to attain the reduction of fuel consumption as well as the reduction of exhaust emission. In order to achieve this object, a lubrication system of an internal combustion engine of the present invention is provided with a generator which is capable of carrying out heat exchange with lubricating oil in the internal combustion engine, wherein an amount of electric power generated by the generator is increased when the temperature of the lubricating oil is lower than a target temperature. According to this lubrication system of an internal combustion engine, it becomes possible to quickly raise the temperature of the lubricating oil to the target temperature with the heat produced by the generator.

### TECHNICAL FIELD

The present invention relates to a lubrication system of an internal combustion engine, and in particular to a system which serves to warm or heat lubricating oil in the internal combustion engine by making use of the heat produced by a generator.

### BACKGROUND ART

In a Patent Document 1, there is disclosed, as a technique of warming or heating lubricating oil in an internal combustion engine, one which is provided with a heater in a path of the lubricating oil.

In a Patent Document 2, there is disclosed a technique which is provided with a water cooling type oil cooler, a bypass passage for allowing lubricating oil to flow through while bypassing the oil cooler, and an electromagnetic valve to regulate the flow rate of the lubricating oil in the oil cooler and the flow rate thereof in the bypass passage, wherein the electromagnetic valve is controlled in such a manner that the lubricating oil can flow through the oil cooler when the temperature of the lubricating oil is higher than a critical or limit oil temperature, or when the temperature of the lubricating oil is lower than the temperature of cooling water.

In a Patent Document 3, there is disclosed a water cooling type alternator system which is provided with an alternator, a housing which is arranged so as to surround the alternator, and a cooling mechanism which is arranged in the housing so as to cool the alternator with water.

In a Patent Document 4, there is disclosed a technique in which when the operating temperature of an internal combustion engine is low, cooling water flows through both an alternator and an engine proper.

In a Patent Document 5, there is disclosed a technique in which an electric heater is provided which serves to heat lubricating oil in an internal combustion engine by making use of electrical energy, wherein when the temperature of the lubricating oil is low and at the same time the internal combustion engine is in a deceleration state, the electric heater is caused to operate with surplus electric power generated by an alternator.

### PRIOR ART DOCUMENTS

### Patent Documents

Patent Document 1: Japanese Patent Application Laid-Open No. 10-131732
Patent Document 2: Japanese Utility Model Application Laid-Open No. 61-12918
Patent Document 3: Japanese Utility Model Application Laid-Open No. 02-139464
Patent Document 4: Japanese Patent Application Laid-Open No. 2008-190533
Patent Document 5: Japanese Patent Application Laid-Open No. 2004-270618

### DISCLOSURE OF THE INVENTION

### Problem to be Solved by the Invention

The present invention has for its object to reduce the friction of an internal combustion engine in a suitable manner when the internal combustion engine is in a cold state, thereby to attain the reduction of fuel consumption as well as the reduction of exhaust emission.

### Means for Solving the Problem

The present invention adopts the following means in order to achieve the above-mentioned object. That is, the present invention is provided with a generator which is capable of carrying out heat exchange with lubricating oil in an internal combustion engine, wherein it is intended to attain the suppression of overheating of the generator as well as the reduction in the friction of the internal combustion engine by heating the lubricating oil with the heat produced by the generator.

Specifically, a lubrication system of an internal combustion engine according to the present invention is provided with:

an internal combustion engine through which lubricating oil circulates;

a generator that is capable of carrying out heat exchange with the lubricating oil in said internal combustion engine; and

control means that raises the temperature of the lubricating oil by means of heat produced by said generator, and supplies the lubricating oil thus raised in temperature to said internal combustion engine.

In cases where the internal combustion engine is in a cold state, etc., the temperature of the lubricating oil becomes low. The lubricating oil has a property in which its viscosity becomes high when the temperature thereof is low. For this reason, friction becomes large in the sliding portions of the internal combustion engine, and the load of an oil pump becomes high.

On the other hand, the generator has a property in which its power generation efficiency becomes low when the temperature thereof is high. For this reason, when the temperature of the generator becomes high, the engine output consumed by driving the generator may become large.

In contrast, it is considered to use a method of carrying out heat exchange between the cooling water of the internal combustion engine and the generator. According to this method, the heat produced by the generator can be conducted to the cooling water. As a result, it is possible to suppress the overheating of the generator, and it is possible to cause the temperature of the cooling water to rise.

However, even if the temperature of cooling water is raised by the above-mentioned method, the temperature of the lubricating oil does not go up in a quick manner, and hence, it is impossible to solve the problem that friction becomes large in the sliding portions of the internal combustion engine, and the load of an oil pump becomes high.

In addition, a method of heating the lubricating oil in the internal combustion engine by means of an electrically operated type oil heater is also considered, but in this case, there is a problem that when the generator is operated so as to operate the oil heater, the temperature of the generator goes up, and the power generation efficiency thereof drops, thus resulting in that the engine output consumed by driving of the generator increases.

Accordingly, in the lubrication system of an internal combustion engine of the present invention, the generator is constructed such that it is able to heat exchange directly with the lubricating oil in the internal combustion engine, wherein the temperature of the lubricating oil is raised with the heat produced by the generator, and the lubricating oil thus raised in temperature is supplied to the internal combustion engine.

According to such an invention, it is possible to make compatible both a quick rise in the temperature of the lubricating oil, and suppression of overheat of the generator. As a result, the friction of the internal combustion engine and the load of the oil pump can be decreased in a suitable manner. When the friction of the internal combustion engine and the load of the oil pump are decreased, it will also become possible to suppress an increase in fuel consumption as well as an increase in exhaust emission.

In the present invention, the control means may make an amount of electric power generated by the generator larger when the temperature of the lubricating oil is low, than when it is high. According to such a control method, the temperature of the lubricating oil can be caused to rise to an appropriate temperature in a quick manner. Also, according to such a method, the amount of heat produced by the generator increases, but the heat of the generator is conducted to the lubricating oil, thus making it possible to avoid an excessive rise in temperature of the generator.

Here, note that the control means may increase the amount of electric power generated by the generator under the condition that the temperature of the lubricating oil is lower than a target temperature which has been set beforehand. As the target temperature referred to herein, there can be used a temperature equivalent to the oil temperature at the time when the warming-up of the internal combustion engine has been completed.

The control means may stop increasing the amount of electric power generated by the generator when the load (the torque required) of the internal combustion engine becomes higher than a reference load which has been set beforehand. If the amount of electric power generated by the generator is increased when the load of the internal combustion engine is high, the torque generated by the internal combustion engine may not reach the required torque. For that reason, the driver of a vehicle with the internal combustion engine mounted thereon may further increase the degree of opening of an accelerator pedal. As a result, the fuel consumption of the internal combustion engine may increase.

In contrast, if the increase in the amount of electric power generated by the generator is stopped when the load of the internal combustion engine is higher than the reference load, it will be possible to avoid an increase in fuel consumption as referred to above. Here, note that when the load of the internal combustion engine becomes high, the amount of heat produced by the internal combustion engine increases. For that reason, the lubricating oil quickly rises in temperature by receiving the heat of the internal combustion engine.

Accordingly, if the increase in the amount of electric power generated by the generator is stopped when the load of the internal combustion engine is higher than the reference load, it will be possible to suppress an increase in fuel consumption, without preventing a rise in temperature of the lubricating oil.

The control means may stop increasing the amount of electric power generated by the generator in cases where the amount of electric power generated by the generator becomes larger than an allowable amount of electric power to be supplied to an electric circuit to which electric power is supplied from the generator. In that case, it is possible to avoid a situation where an excessive amount of electric power is supplied to the electric circuit. Here, note that in cases where the lubrication system of an internal combustion engine is provided with a heater that serves to heat the lubricating oil by making use of electrical energy, the heater may be driven to operate by surplus electric power generated by the generator. In that case, the temperature rise of the lubricating oil is further facilitated by means of the heat produced by the generator and the heat produced by the heater.

Incidentally, the generator has a relatively large heat capacity. For that reason, if heat exchange is carried out between the generator and the lubricating oil when the temperature of the generator is low, particularly when the temperature of the generator is lower than the temperature of the lubricating oil, the rate of rise in temperature of the lubricating oil may decrease on the contrary.

Accordingly, the control means of the present invention may decrease an amount of the lubricating oil to be heat exchanged with the generator in a period of time in which the temperature of the generator becomes lower than the temperature of the lubricating oil. The term “decrease” referred to herein is assumed to include a case in which the amount of the lubricating oil to be heat exchanged with the generator becomes zero.

If the amount of the lubricating oil to be heat exchanged with the generator is limited in this manner, it will be possible to avoid a situation where the heat of the lubricating oil is taken by the generator. Here, note that as the period of time in which the temperature of the generator becomes lower than the temperature of the lubricating oil, there can be mentioned, by way of example, a period of time from the time of start-up of the internal combustion engine until a predetermined period of time elapses.

During a start-up operation of the internal combustion engine and/or immediately after the start-up thereof, the alternator does not substantially generate electricity, and hence, the temperature of the alternator does not substantially go up. On the other hand, the lubricating oil goes up in temperature more than a little by receiving the heat of compression and the heat of combustion which are produced in the internal combustion engine. Therefore, during the start-up operation of the internal combustion engine and/or immediately after the start-up thereof, the temperature of the generator becomes lower than the temperature of the lubricating oil.

However, as described above, when the amount of electric power generated by the generator is increased, the rate of rise in temperature of the generator will become higher than the rate of rise in temperature of the lubricating oil. Therefore, when the predetermined period of time elapses from the time of start-up of the internal combustion engine, the temperature of the generator becomes higher than the temperature of the lubricating oil.

Here, the above-mentioned predetermined period of time can have been obtained beforehand by an adaptation operation using experiments, etc. In addition, the above-mentioned predetermined period of time may be set in such a manner that it is longer when the temperature of the generator at the time of start-up of the internal combustion engine is low than when it is high. That is, the above-mentioned predetermined period of time may be changed (corrected) in accordance with the temperature of the generator at the time of start-up of the internal combustion engine.

In addition, as a method of decreasing the amount of the lubricating oil to be heat exchanged with the generator, there can be mentioned, by way of example, a method in which the lubrication system is additionally provided with a bypass passage to cause the lubricating oil to flow through while bypassing the alternator, and a flow rate regulating mechanism to change a ratio of an amount of the lubricating oil which flows through said bypass passage with respect to an amount of the lubricating oil which passes by way of said generator, wherein the flow rate regulating mechanism is controlled in such a manner as to decrease the amount of the lubricating oil to be heat exchanged with the generator.

### Effects of the Invention

According to the present invention, the friction of the internal combustion engine can be reduced by using the heat produced by the generator. As a result, it also becomes possible to attain the reduction of fuel consumption of the internal combustion engine as well as the reduction of exhaust emission thereof.

### BRIEF DESCRIPTION OF THE DRAWINGS

FIG. 1 is a view showing the schematic construction of a lubrication system of an internal combustion engine in a first embodiment.

FIG. 2 is a view showing the schematic construction of an oil cooler.

FIG. 3 is a flow chart showing an oil temperature control routine in the first embodiment.

FIG. 4 is a flow chart showing an oil temperature control routine in a second embodiment.

FIG. 5 is a view showing another construction example of a lubrication system of an internal combustion engine in the second embodiment.

FIG. 6 is a view showing the schematic construction of a lubrication system of an internal combustion engine in a third embodiment.

FIG. 7 is a flow chart showing an oil temperature control routine in the third embodiment.

FIG. 8 is a view showing the schematic construction of a lubrication system of an internal combustion engine in a fourth embodiment.

FIG. 9 is a flow chart showing an oil temperature control routine in the fourth embodiment.

### THE BEST MODE FOR CARRYING OUT THE INVENTION

Hereinafter, specific embodiments of the present invention will be described based on the attached drawings. However, the dimensions, materials, shapes, relative arrangements and so on of component parts described in the embodiments are not intended to limit the technical scope of the present invention to these alone in particular as long as there are no specific statements.

### First Embodiment

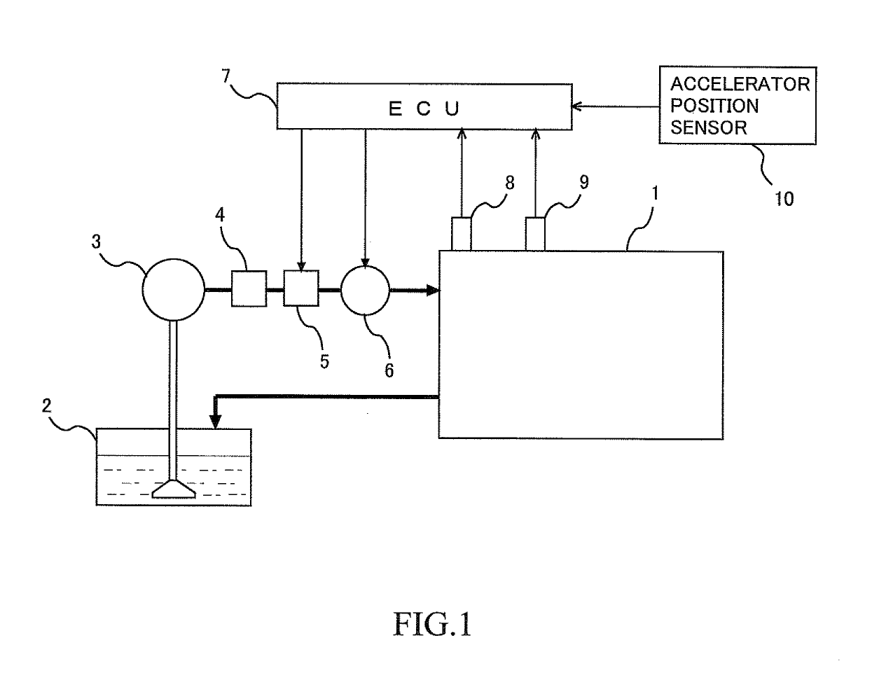

First, reference will be made to a first embodiment of the present invention based on FIGS. 1 through 3. FIG. 1 is a view showing the schematic construction of a lubrication system of an internal combustion engine. In FIG. 1, the lubrication system of an internal combustion engine is provided with a lubricating oil storage tank 2 for storing oil as lubricating oil in an internal combustion engine 1. The lubricating oil storage tank 2 may be an oil pan mounted on a lower part of the internal combustion engine 1, or may be a tank which is arranged separately from the internal combustion engine 1.

The oil stored in the lubricating oil storage tank 2 is sucked up by an oil pump 3, and is delivered toward the internal combustion engine 1. The oil delivered from the oil pump 3 is supplied to the internal combustion engine 1 by way of an oil filter 4, an oil cooler 5, and an alternator 6 in a sequential manner. The oil supplied to the internal combustion engine 1 returns to the lubricating oil storage tank 2, after passing through an unillustrated oil passage.

Here, the above-mentioned oil pump 3 is a mechanical pump which is operatively connected with an output shaft (crankshaft) of the internal combustion engine 1 through a belt or a gear mechanism so that it is driven by the rotational energy of the crankshaft, or an electric pump which is driven by the rotational energy of an electric motor. The above-mentioned oil filter 4 is a filtering device which removes solid particles contained in the oil.

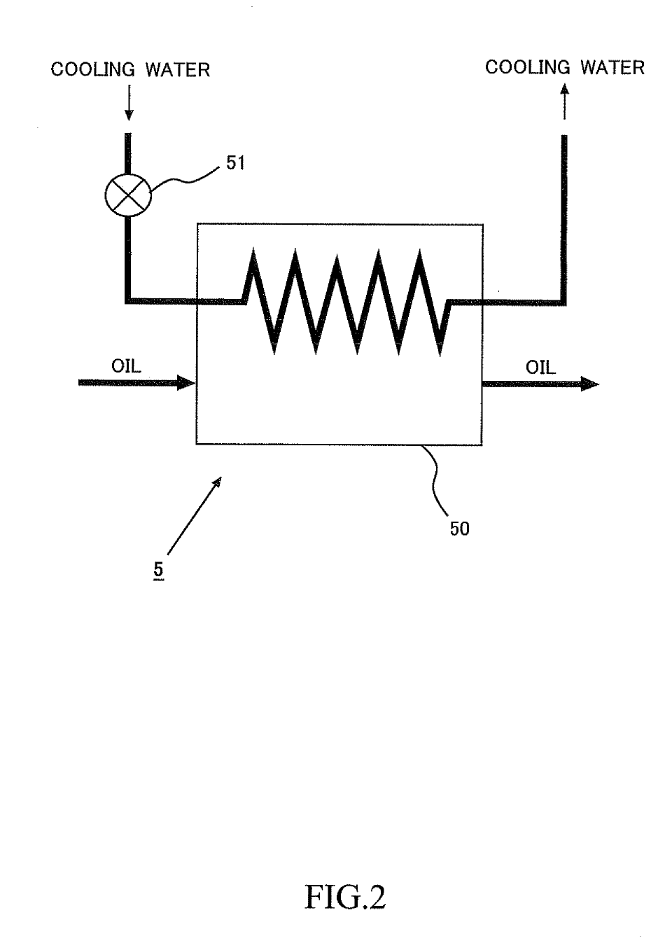

The above-mentioned oil cooler 5 is a heat exchanger for cooling the oil. As shown in FIG. 2, the oil cooler 5 of this embodiment is provided with a heat exchanger 50 that carries out heat exchange between cooling water of the internal combustion engine 1 and the oil, and a flow rate regulating valve 51 that regulates an amount of the cooling water which flows into the heat exchanger 50. The flow rate regulating valve 51 is an electrically operated flow rate regulating valve which is driven to open and close by means of a step motor, a solenoid, etc.

Here, note that as the oil cooler 5, there may be used an oil cooler which is provided with an air-cooled heat exchanger, a bypass passage that causes the oil to flow through while bypassing the heat exchanger, and a changeover valve that serves to cause the oil to flow into either one of the heat exchanger and the bypass passage. The changeover valve may be an electrically operated valve which is driven to open and close by means of a step motor, a solenoid, etc., or may be a thermostat type valve which carries out switching or changeover operation according to the temperature of the oil.

In addition, as the flow rate regulating valve 51 of the oil cooler 5, there can also be used a thermostat type valve which is closed (blocked) when the temperature of the oil is less than a fixed temperature, and which is opened when the temperature of the oil is not less than the fixed temperature.

Then, the above-mentioned alternator 6 is a generator which is operatively connected with the unillustrated output shaft (crankshaft) of the internal combustion engine 1 through a belt, etc., for converting the kinetic energy (rotational energy) transmitted thereto from the output shaft into electrical energy.

The above-mentioned alternator 6 is constructed in such a manner that it can directly carry out heat exchange with the oil. As a method of achieving heat exchange between the alternator 6 and the oil, there can be mentioned, for example, a method in which an oil passage is formed in a housing of the alternator 6 whereby the heat of a rotator, etc., is made to conduct to the oil through a wall surface of the housing, or a method in which oil is caused to flow through or disperse into the interior of the alternator 6 whereby the heat of a rotator (rotor), etc., is made to conduct to the oil, or the like.

An ECU 7 for controlling the internal combustion engine 1 and the individual devices and equipment as referred to above is attached to the lubrication system of an internal combustion engine as constructed in this manner. The ECU 7 is an electronic control unit which includes a CPU, a ROM, a RAM, a backup RAM, and so on.

A variety of kinds of sensors such as an oil temperature sensor 8, a water temperature sensor 9, an accelerator position sensor 10, and so on are electrically connected to the ECU 7. The oil temperature sensor 8 is a sensor which detects the temperature of the oil flowing through the internal combustion engine 1, and is arranged at the downstream of the alternator 6 in the direction of flow of the oil. The water temperature sensor 9 is a sensor which detects the temperature of the cooling water circulating through the internal combustion engine 1, and is arranged at the upstream of the oil cooler 5 in the direction of flow of the cooling water. The accelerator position sensor 10 is a sensor which outputs an electrical signal corresponding to the amount of operation (accelerator opening) of an unillustrated accelerator pedal.

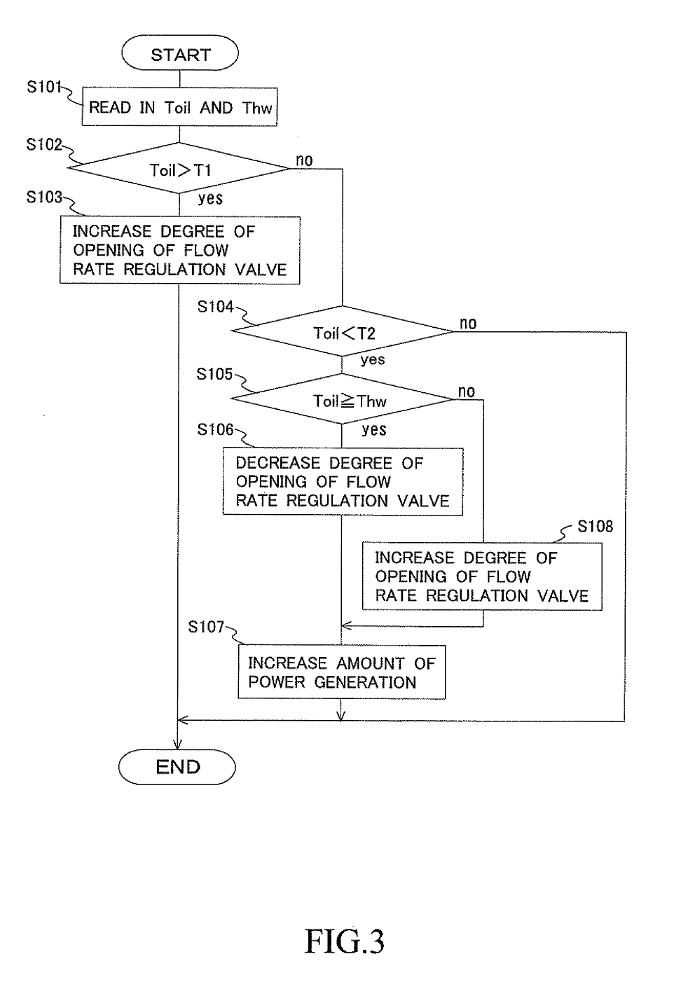

The ECU 7 electrically controls the oil cooler 5 and the alternator 6 based on the output signals of the above-mentioned variety of kinds of sensors. For example, the ECU 7 controls the oil cooler 5 and the alternator 6 according to an oil temperature control routine as shown in FIG. 3. The oil temperature control routine is a routine which has been beforehand stored in the ROM of the ECU 7, and is executed by the ECU 7 in a periodic manner.

In the oil temperature control routine of FIG. 3, the ECU 7 first executes the processing of step S101. In step S101, the ECU 7 reads in an output signal (oil temperature) Toil of the oil temperature sensor 8 and an output signal (cooling water temperature) Thw of the water temperature sensor 9.

In S102, the ECU 7 determines whether the oil temperature Toil thus read in the above-mentioned step S101 is higher than a predetermined temperature T1. The predetermined temperature T1 is a lower limit value of a temperature at which the power generation efficiency of the alternator 6 falls within an allowable range, or is a little lower than the lower limit value, and which has been beforehand obtained experimentally.

In cases where an affirmative determination is made in the above-mentioned step S102, the process of the ECU 7 goes to step S103, in which oil temperature lowering processing is carried out. Specifically, the ECU 7 increases the degree of opening of the flow rate regulating valve 51 of the oil cooler 5 from the present point in time. At that time, an amount of increase of the degree of opening of the flow rate regulating valve 51 may be set in such a manner that it becomes larger when the oil temperature Toil is high than when it is low.

When the oil temperature lowering processing as described above is carried out, the amount of the cooling water flowing through the oil cooler 5 increases. For that reason, the amount of heat conducted from the oil to the cooling water in the oil cooler 5 increases. As a result, the temperature of the oil flowing out from the oil cooler 5, in other words, the temperature of the oil flowing into the alternator 6, drops. Therefore, it is possible to suppress a decrease in the power generation efficiency of the alternator 6 due to its overheating, and it is also possible to suppress an increase in the engine output consumed by driving of the alternator 6.

Here, note that in cases where the oil pump 3 is constructed such that the amount of discharge thereof can be changed, the ECU 7 may cause the amount of heat conducted from the alternator 6 to the oil per unit time to be increased by increasing the amount of discharge (discharge volume) of the oil pump 3 in the above-mentioned step S103. In that case, it becomes possible to lower the temperature of the alternator 6 more early or quickly.

In addition, in cases where a negative determination is made in the above-mentioned step S102, the process of the ECU 7 goes to step S104. In step S104, the ECU 7 determines whether the oil temperature Toil read in the above-mentioned step S101 is lower than a predetermined temperature T2. The predetermined temperature T2 is a temperature which is lower than the above-mentioned predetermined temperature T1, and which is set to be lower than the oil temperature at the time of completion of warming-up of the internal combustion engine 1.

In cases where a negative determination is made in the above-mentioned step S103 (Toil≧T2), the ECU 7 once ends the execution of this routine. On the other hand, in cases where an affirmative determination is made in the above-mentioned step S103 (Toil<T2), the ECU 7 executes oil temperature raising processing in step S105 and onwards.

In the oil temperature raising processing, first in S105, the ECU 7 makes a comparison between the oil temperature Toil and the cooling water temperature Thw which have been read in the above-mentioned step S101. That is, the ECU 17 determines whether the oil temperature Toil is not less than the cooling water temperature Thw. In cases where an affirmative determination is made in step S105 (Toil Thw), the ECU 7 goes to step S106.

In S106, the ECU 7 decreases the degree of opening of the flow rate regulating valve 51 of the oil cooler 5 (preferably, to a fully closed state) from the present point in time. Subsequently, the ECU goes to S107, and increases the amount of power generation of the alternator 6. An amount of increase of the power generation at that time may be set in such a manner that it becomes larger when the oil temperature Toil is low than when it is high.

When the processing of steps S106, S107 is carried out in this manner, the amount of heat conducted from the oil to the cooling water in the oil cooler 5 is decreased. As a result of this, the temperature of the oil is suppressed from lowering. Moreover, because the amount of heat produced by the alternator 6 increases, the amount of heat conducted from the alternator 6 to the oil increases. As a result, the temperature of the oil flowing into the internal combustion engine 1 goes up quickly, and the viscosity of the oil also decreases in accordance therewith. Therefore, the friction loss of the internal combustion engine 1 is reduced, and at the same time, the load of the oil pump is also reduced.

On the other hand, in cases where a negative determination is made in the above-mentioned step S105 (Toil<Thw), the ECU 7 goes to step S108. In step S108, the degree of opening of the flow rate regulating valve 51 of the oil cooler 5 is increased from the present point in time. Subsequently, the ECU goes to S107, and increases the amount of power generation of the alternator 6.

When the processing of steps S108, S107 is carried out in this manner, the heat of the cooling water is conducted to the oil in the oil cooler 5, and at the same time, the heat of the alternator 6 is also conducted to the oil. That is, the oil receives the heat of the cooling water, too, in addition to the heat of the alternator 6. As a result, the temperature of the oil comes to rise much more quickly.

Here, note that in cases where the oil pump 3 is constructed such that the amount of discharge thereof can be changed, the ECU 7 may decrease the amount of discharge of the oil pump 3 from the present point in time in the above-mentioned step S106 or S108. In that case, the amount of heat received by the oil per unit amount thereof from the alternator 6 and the cooling water increases. As a result, the temperature of the oil comes to rise much more quickly.

In addition, the above-mentioned oil temperature raising processing may be ended at the time when the temperature of the oil has risen to the predetermined temperature T2, or when the difference between the temperature of the oil and the predetermined temperature T2 has fallen within the allowable range.

As described above, control means according to the present invention is achieved by carrying out the oil temperature control routine of FIG. 3 by means of the ECU 7. Accordingly, it is possible to reduce the friction of the internal combustion engine 1 by making use of the heat produced by the alternator 6 during the time when the internal combustion engine 1 is in a cold state. As a result, it also becomes possible to attain the reduction of fuel consumption as well as the reduction of exhaust emission.

### Second Embodiment

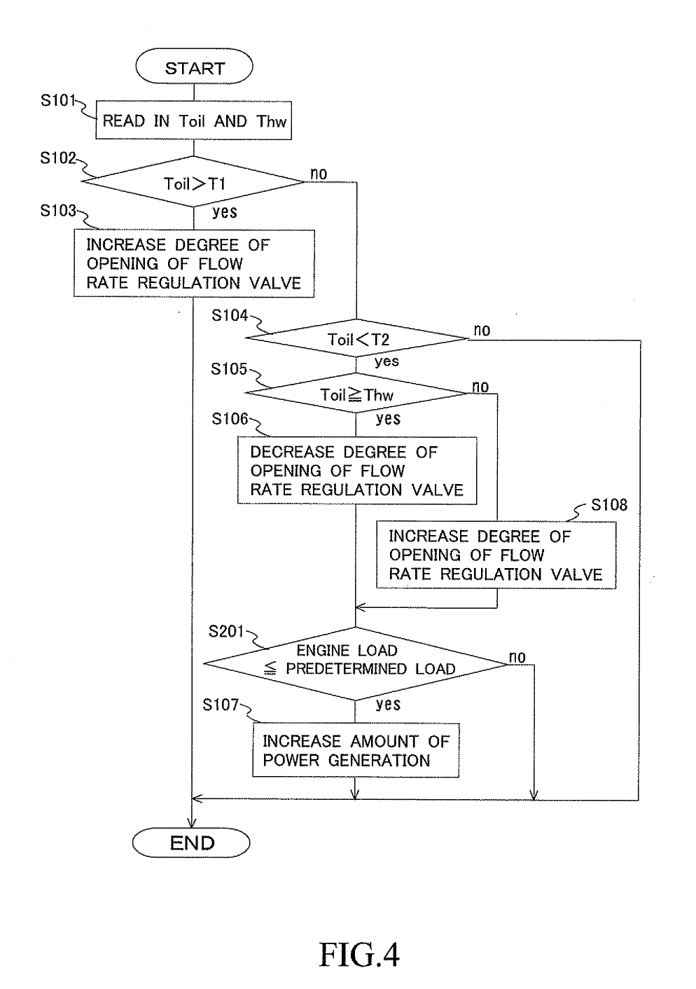

Now, a second embodiment of a lubrication system of an internal combustion engine according to the present invention will be described based on FIG. 4. Here, a construction different from that of the above-mentioned first embodiment will be described, and an explanation of the same construction will be omitted.

The difference between the above-mentioned first embodiment and this second embodiment resides in the feature that a method of carrying out the oil temperature raising processing is changed in accordance with the load of the internal combustion engine 1. That is, the difference of this second embodiment from the above-mentioned first embodiment is that when the load of the internal combustion engine 1 is low, the amount of heat produced by the alternator 6 is made to increase, similar to the above-mentioned first embodiment, but when the load of the internal combustion engine 1 is high, a rise in the temperature of the oil is attained without increasing the amount of heat produced by the alternator 6.

FIG. 4 is a flow chart showing an oil temperature control routine in this second embodiment. In FIG. 4, the same symbols are attached to the same processes as those in the above-mentioned oil temperature control routine of the first embodiment (see FIG. 3).

In the oil temperature control routine of FIG. 4, a step S201 is carried out after the processing of step S106 or S108 has been carried out. In step S201, the ECU 7 determines whether the load of the internal combustion engine 1 (hereinafter, engine load) is not more than a predetermined load. As the engine load referred to herein, there may be used a numerical value which is decided by using, as parameters, the output signal of the accelerator position sensor 10 (the degree of opening of the accelerator pedal) and the number of engine revolutions per unit time, or there may also be used the degree of opening of the accelerator pedal. In addition, the predetermined load is an engine load under which it is considered that the temperature of the oil can be raised in a quick manner by the heat which is produced by the internal combustion engine 1, and such an engine load has been obtained beforehand by an adaptation operation using experiments, etc.

In cases where an affirmative determination is made in the above-mentioned step S201, the ECU 7 carries out the processing of step S107, similar to the above-mentioned first embodiment. On the other hand, in cases where a negative determination is made in the above-mentioned step S201, the process of the ECU 7 skips the processing of step S107. In that case, the engine output consumed by driving of the alternator 6 can be reduced, without preventing a rise in the temperature of the oil. Therefore, it is possible to cause the temperature of the oil to rise, while suppressing a reduction in drivability of the internal combustion engine 1 as well as an increase in the fuel consumption.

Here, note that in this embodiment, reference has been made to an example in which the increase in the amount of electric power generated by the alternator 6 is stopped when the engine load is higher than the predetermined load, but in cases where the amount of increase in the power generation of the alternator 6 can not be fully consumed by charging a storage battery (battery), and/or by operating or driving electric loads (e.g., an air conditioner, an electric windshield wiper, a defogger, etc.) which are mounted on a vehicle, the increase in the amount of power generation of the alternator 6 may also be stopped or decreased.

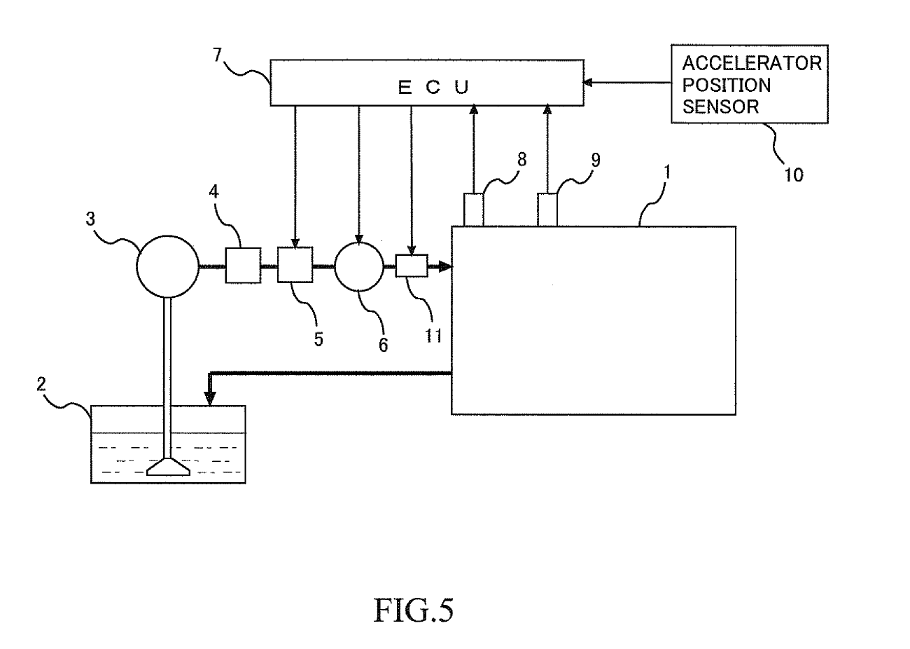

However, in cases where the lubrication system of the internal combustion engine is provided with an oil heater 11 which serves to heat the oil flowing out from the alternator 6 with electric power, as shown in FIG. 5, the oil heater 11 may be caused to operate by an increased amount of electric power generated by the alternator 6. In that case, oil is also warmed or heated with the heat of the oil heater 11 in addition to the heat produced by the alternator 6, so it becomes possible to cause the temperature of the oil to rise much more quickly.

In addition, in the construction as shown in FIG. 5, in cases where a sufficient amount of electricity is stored in the battery, the oil heater 11 may be driven to operate, without increasing the amount of electric power generated by the alternator 6. Stated in another way, the amount of power generation of the alternator 6 may be increased only in the case where sufficient electricity has not been stored in the battery (i.e., in cases where the battery is in a state capable of being charged).

According to such control, it is possible to suppress an increase in the engine output consumed by driving of the alternator 6 to a minimum level, and hence, it also becomes possible to suppress an increase in the fuel consumption resulting from the increase in the amount of power generation of the alternator 6.

### Third Embodiment

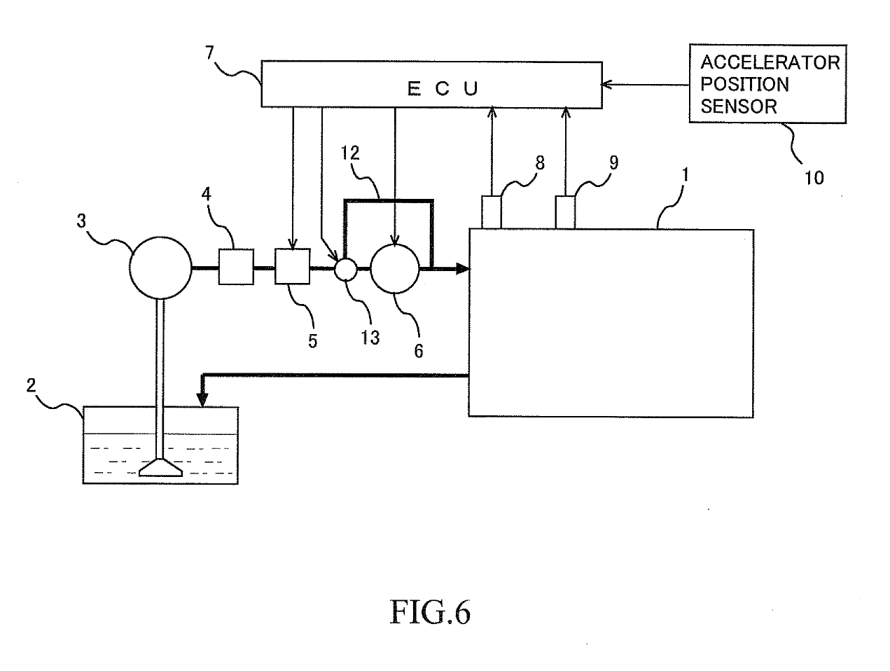

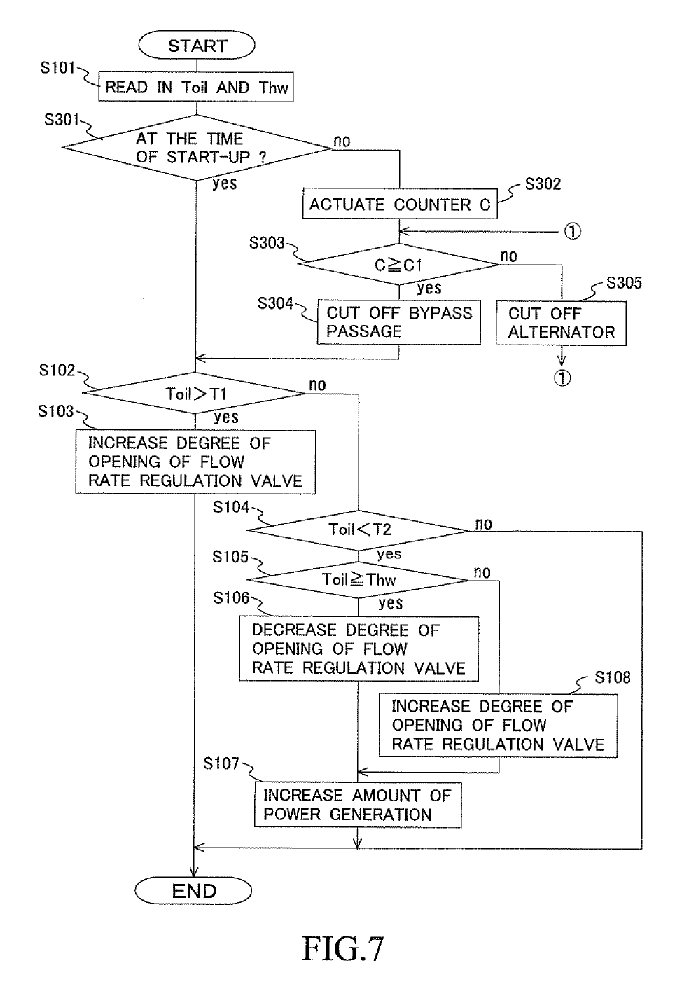

Next, a third embodiment of a lubrication system of an internal combustion engine according to the present invention will be described based on FIG. 6 and FIG. 7. Here, a construction different from that of the above-mentioned first embodiment will be described, and an explanation of the same construction will be omitted.

The difference between the above-mentioned first embodiment and this third embodiment resides in the feature that heat exchange between the alternator 6 and oil is prohibited when the temperature of the alternator 6 is low. That is, the difference between the above-mentioned first embodiment and this third embodiment is that oil flows while bypassing the alternator 6 when the temperature of the alternator 6 is low.

FIG. 6 is a view showing the schematic construction of the lubrication system of an internal combustion engine in this third embodiment. In FIG. 6, the same symbols are attached to the same components as those in the above-mentioned first embodiment (see FIG. 1).

As shown in FIG. 6, the lubrication system of an internal combustion engine of this third embodiment is provided with a bypass passage 12 for allowing oil to flow through while bypassing the alternator 6, and a changeover valve 13 that serves to cause the oil to flow into either one of the alternator 6 and the bypass passage 12, wherein the changeover valve 13 is an electrically operated valve which is driven to open and close by means of a step motor, a solenoid, etc., and is controlled by the ECU 7.

The alternator 6 has a relatively large heat capacity, and hence, if oil passes through the alternator 6 when the temperature of the alternator 6 is lower than the temperature of the oil, the heat of the oil will be conducted to the alternator 6. As a result, the rate of rise in temperature of the oil may actually drop on the contrary.

On the other hand, according to the lubrication system of an internal combustion engine of this third embodiment, when the temperature of the alternator 6 is lower than the temperature of the oil, it becomes possible to cause the oil to flow through while bypassing the alternator 6. Accordingly, it is possible to avoid a decrease in the rate of rise in temperature of the oil.

Here, note that as a method of determining whether the temperature of the alternator 6 is lower than the temperature of the oil, it is considered to adopt a method of detecting the temperature of the alternator 6 and comparing it with an output signal of the oil temperature sensor 8, but in this embodiment, there is used a method in which it is assumed that the temperature of the alternator 6 becomes lower than the temperature of the oil within a predetermined period of time from the instant when the internal combustion engine 1 has been started.

When the internal combustion engine 1 is started, the temperature of the alternator 6 and the temperature of the oil become substantially equal to each other. During the start-up operation of the internal combustion engine 1 and immediately after the start-up thereof, the oil receives the heat of compression and the heat of combustion of the internal combustion engine 1, so that the temperature of the oil is thereby raised. On the other hand, because the alternator 6 does not substantially generate electricity during the start-up operation of the internal combustion engine 1 and immediately after the start-up thereof, the temperature of the alternator 6 does not substantially go up. As a result, the temperature of the oil tends to be higher than the temperature of the alternator 6 during the start-up of the internal combustion engine 1 and immediately after the start-up thereof.

Accordingly, the period of time taken for the temperature of the alternator 6 to become equal to or higher than the temperature of the oil from the time of start-up of the internal combustion engine 1 (from the start of cranking) has been experimentally obtained beforehand, and the period of time thus obtained has been set as the predetermined period of time.

Hereinafter, reference will be made to oil temperature control in this embodiment in line with FIG. 7. FIG. 7 is a flow chart showing an oil temperature control routine in this embodiment. In FIG. 7, the same symbols are attached to the same processes as those in the above-mentioned oil temperature control routine of the first embodiment (see FIG. 3).

In the oil temperature control routine of FIG. 7, the ECU 7 carries out the processing of step S301 after having executed the processing of S101. In step S301, the ECU 7 determines whether the internal combustion engine 1 is at the time of starting (i.e., at the time of starting of cranking).

In cases where a negative determination is made in the above-mentioned step S301, the ECU 7 carries out the processing of step S102 and onwards. On the other hand, in cases where an affirmative determination is made in the above-mentioned step S301, the process of the ECU 7 goes to step S302. In step S302, the ECU 7 actuates a counter C. The counter C is a counter which serves to measure the time elapsed from the start-up of the internal combustion engine 1.

After the execution of the processing of step S302, the process of the ECU 7 goes to step S303. In step S303, the ECU 7 determines whether the time measured by the counter C is equal to or larger than a predetermined period of time Cl.

In cases where a negative determination is made in step S303, the process of the ECU 7 goes to step S305. In step S305, the ECU 7 controls the changeover valve 13 in such a manner that the flow of oil to the alternator 6 is cut off or blocked (i.e., the flow of oil to the bypass passage 12 is permitted). In this case, the oil flows without passing through the alternator 6, so it is possible to avoid a situation in which the heat of the oil is taken by the alternator 6.

Here, note that when the internal combustion engine 1 is in a start-up complete state at the time of carrying out the processing of step S305, the ECU 7 may control to increase the amount of power generation of the alternator 6. In that case, it is possible to make earlier the time at which the temperature of the alternator 6 becomes higher than the temperature of the oil.

Subsequently, in cases where an affirmative determination is made in step S303, the process of the ECU 7 goes to step S304. In step S304, the ECU 7 controls the changeover valve 13 in such a manner that the flow of oil to the bypass passage 12 is blocked (i.e., the flow of oil to the alternator 6 is permitted). In this case, the oil flows by way of the alternator 6, so the heat of the alternator 6 can be conducted to the oil. After the execution of the processing of step S304, the ECU 7 carries out the processing of step S102 and onwards.

According to the embodiment described above, when the temperature of the alternator 6 is lower than the temperature of the oil, the heat of the oil will not be taken by the alternator 6. As a result, it is possible to avoid a situation where the rate of rise in temperature of the oil is unnecessarily decreased.

Here, note that in the oil temperature control routine shown in FIG. 7, the processing of steps S301 through S305 is carried out after the processing of step S101 has been carried out, but in cases where an affirmative determination is made in step S104, the processing of steps S301 through S305 may be carried out. That is, only in cases where the temperature of the oil (the oil temperature) Toil is lower than the predetermined temperature T2, the processing of steps S301 through S305 may be carried out. In addition, in the oil temperature control routine shown in FIG. 7, the processing of step S102 and onwards may be replaced with the same processing as in the above-mentioned second embodiment.

In this embodiment, reference has been made to an example in which oil is caused to bypass on the assumption that the temperature of the alternator 6 becomes lower than the temperature of the oil within the predetermined period of time from the instant when the internal combustion engine 1 has been started. However, in cases where a sensor is provided which serves to measure the temperature of the alternator 6 (e.g., a sensor which measures the temperature of alternator 6 itself, or a sensor which measures the temperature of the oil flowing out from the alternator 6, or the like), the oil may be caused to bypass the alternator 6 when an output signal of the sensor is lower than the oil temperature Toil. In addition, the oil may be caused to bypass the alternator 6 in a period of time from the time of start-up of the internal combustion engine 1 until the alternator 6 becomes able to operate.

Although in this embodiment, reference has been made to an example in which all the oil flows through the bypass passage 12 during the predetermined period of time from the time of start-up of the internal combustion engine 1, it may be constructed such that a small amount of oil flows through the alternator 6. At that time, the amount of the oil flowing through the alternator 6 may be a fixed value, but can also be changed according to the difference between the temperature of the alternator 6 and the temperature of the oil.

For example, the amount of the oil flowing through the alternator 6 may be made larger when the difference between the temperature of the alternator 6 and the temperature of the oil is large, than when the difference is small. Here, note that the difference between the temperature of the alternator 6 and the temperature of the oil becomes smaller as the time elapsed from the start-up of the internal combustion engine 1 becomes longer. Accordingly, the amount of the oil flowing through the alternator 6 may be made larger when the elapsed time from the start-up of the internal combustion engine 1 is long, than when the elapsed time is short.

As described above, when a small amount of oil comes to flow into the alternator 6, it becomes possible to increase the rate of rise in temperature of the alternator 6, without decreasing the rate of rise in temperature of the oil to an excessive extent.

### Fourth Embodiment

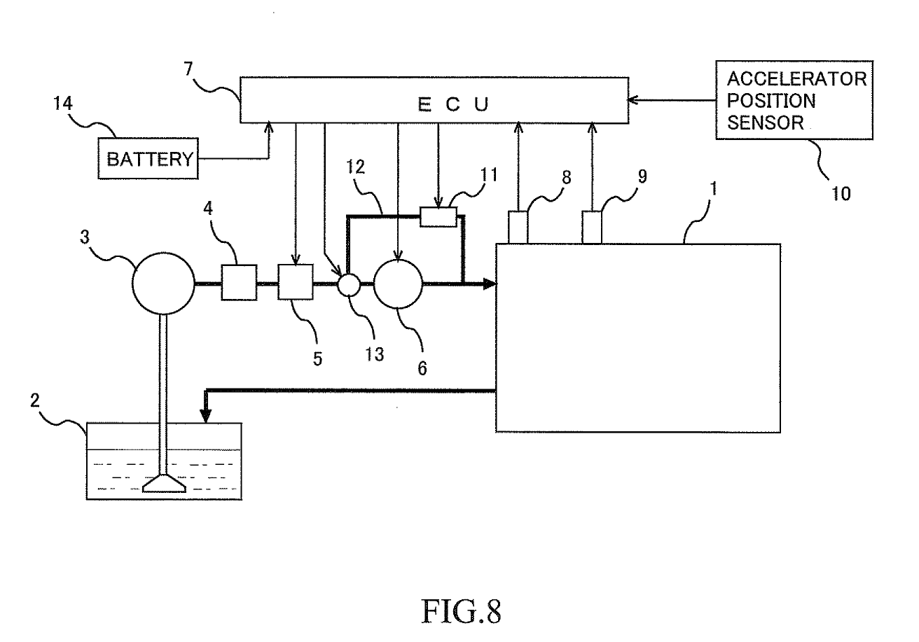

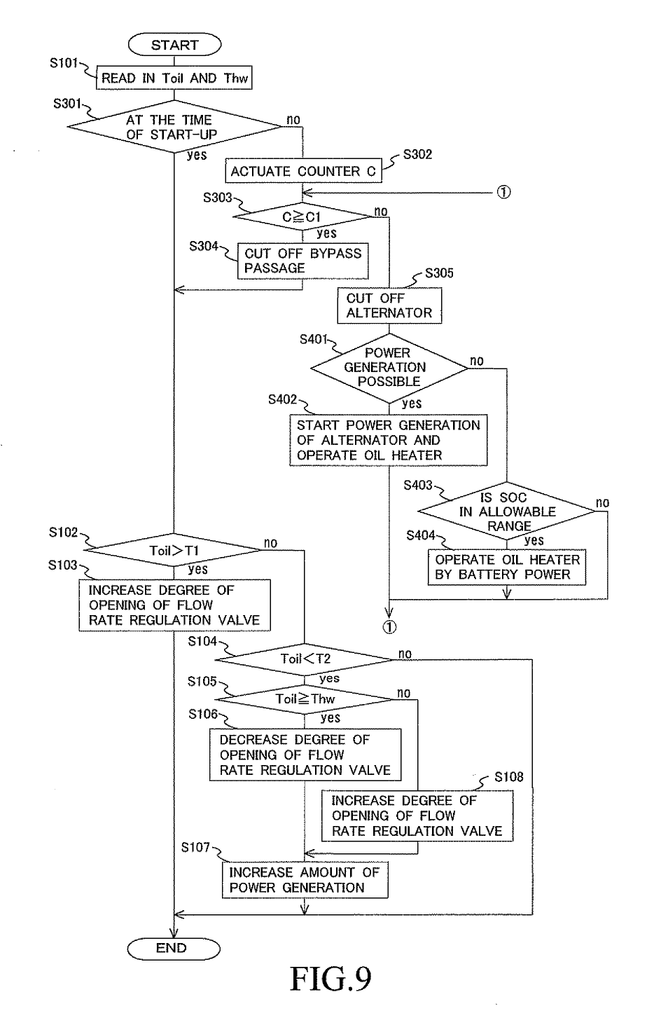

Now, a fourth embodiment of a lubrication system of an internal combustion engine according to this embodiment will be described based on FIG. 8 and FIG. 9. Here, a construction different from that of the above-mentioned third embodiment will be described, and an explanation of the same construction will be omitted.

In the above-mentioned third embodiment, reference has been made to an example in which when the temperature of the alternator 6 is lower than the temperature of the oil, the oil is caused to flow through while bypassing the alternator 6. On the other hand, in this fourth embodiment, reference will be made to an example in which when the temperature of the alternator 6 is lower than the temperature of the oil, the oil is caused to flow through while bypassing the alternator 6, and at the same time, the oil having bypassed the alternator 6 is heated.

FIG. 8 is a view showing the schematic construction of the lubrication system of an internal combustion engine in this fourth embodiment. In FIG. 8, the same symbols are attached to the same components as those in the above-mentioned third embodiment (see FIG. 6).

The lubrication system of an internal combustion engine shown in FIG. 8 is provided with an oil heater 11 for heating the oil flowing through the bypass passage 12. The oil heater 11 is an electrically operated type heating device which serves to convert into heat energy the electrical energy which has been generated by the alternator 6 and/or the electrical energy which has been charged and stored in the battery 14.

In the lubrication system for an internal combustion engine as constructed in this manner, when the temperature of the alternator 6 is lower than the temperature of the oil, the ECU 7 controls the changeover valve 13 in such a manner that the flow of oil to the alternator 6 is blocked (i.e., the flow of oil to the bypass passage 12 is permitted), and at the same time, operates the oil heater 11.

At that time, when the state of charge (SOC) of the battery 14 is not less than a lower limit amount which has been set beforehand, the ECU 7 may operate the oil heater 11 by making use of the electric power of the battery 14, whereas when the state of charge of the battery 14 is less than the lower limit amount, the ECU 7 may operate the oil heater 11 with the electric power generated by the alternator 6. In addition, the ECU 7 may operate the oil heater 11 with the use of the electric power generated by the alternator 6, without regard to the state of charge of the battery 14.

However, during the start-up operation of the internal combustion engine 1 (during cranking) or immediately after the start-up thereof, the combustion stability of the internal combustion engine 1 becomes low, so there is a possibility that the power generation by the alternator 6 or an increase in the amount of power generation of the alternator 6 may not be able to be carried out.

Accordingly, when the power generation by the alternator 6 is not able to be carried out, the oil heater 11 may be operated by the use of the electric power of the battery 14, whereas after the power generation by the alternator 6 has become able to be carried out, the oil heater 11 may be operated by the use of the electric power generated by the alternator 6.

If the oil heater 11 is driven to operate according to such a method, it will become possible to raise the temperature of the oil up to a desired temperature range at an earlier period of time. Here, note that if the electric power of the battery 14 is supplied to the oil heater 11 when the amount of charge of the battery 14 is small, the operation of a starter motor may become unstable, and hence, when the amount of charge of the battery 14 is small, it is preferable to stop the operation of the oil heater 11 using the electric power of the battery 14.

Hereinafter, reference will be made to oil temperature control in this embodiment in line with FIG. 9. FIG. 9 is a flow chart showing an oil temperature control routine in this embodiment. In FIG. 9, the same symbols are attached to the same processes as those in the above-mentioned third embodiment (see FIG. 7).

In FIG. 9, the ECU 7 carries out the processing of step S401 after having executed the processing of S305. In step S401, the ECU 7 determines whether the power generation by the alternator 6 is possible. For example, in cases where the internal combustion engine 1 is in a start-up complete state, and/or in cases where an amount of change of the number of engine revolutions per unit time is in an allowable range which has been set beforehand, the ECU 7 makes a determination that the power generation by the alternator 6 is possible.

In cases where an affirmative determination is made in the above-mentioned step S401, the process of the ECU 7 goes to step S402, in which the power generation by the alternator 6 is started, and at the same time, the oil heater 11 is operated by the use of the electric power generated by the alternator 6. At that time, the ECU 7 adds an amount of electric power necessary for the operation of the oil heater 11 to the amount of electric power generated by the alternator 6. As a result, it is possible to facilitate the temperature rise of the oil as well as the temperature rise of the alternator 6.

On the other hand, in cases where a negative determination is made in the above-mentioned step S401, the process of the ECU 7 goes to step S403. In step 403, the ECU 7 determines whether the state of charge (SOC) of the battery 14 is within an allowable range. The allowable range in that case is a range of the amount of charge in which both the driving of the starter motor and the driving of the oil heater 11 can be carried out in a satisfactory manner.

In cases where an affirmative determination is made in the above-mentioned step S403, the process of the ECU 7 goes to step S404. In step S404, the ECU 7 operates the oil heater 11 by the use of the electric power stored in the battery 14. As a result, it becomes possible to attain heating of oil under the condition where the oil can not be heated by the use of the heat produced by the alternator 6.

The ECU 7 carries out the processing of step S303 again after the execution of the processing of step S402 or S404.

According to the embodiment described above, oil can be heated even in cases where the oil can not be heated with the heat produced by the alternator 6. As a result, the temperature of the oil goes up to a desired temperature range at an earlier period of time.

In addition, because the operation/nonoperation of the oil heater 11 can be controlled according to the state of charge of the battery 14, it also becomes possible to avoid a situation where the operation of the starter motor is made unstable due to the operation of the oil heater 11.

Here, note that in cases where the oil heater 11 is driven to operate, while increasing the amount of electric power generated by the alternator 6, as shown in the above-mentioned step S402, it may be constructed such that the most part of oil will flow through the bypass passage 12, and the remaining small amount of oil will flow through the alternator 6. In that case, it is also possible to facilitate the temperature rise of the alternator 6, while facilitating the temperature rise of the oil. Moreover, in the oil temperature control routine shown in FIG. 9, the processing of step S102 and onwards may be replaced with the same processing as in the above-mentioned second embodiment.

The first through fourth embodiments as described above can be carried out by being combined with one another wherever possible. In addition, in the above-mentioned first through fourth embodiments, reference has been made to an example in which the heating of oil is carried out by means of the alternator 6 and/or the oil heater 11 when the temperature of the oil is lower than the predetermined temperature T2, but the oil may be heated by the alternator 6 and/or the oil heater 11 when the friction of the internal combustion engine 1 is larger than an upper limit value which has been set beforehand, or the above-mentioned predetermined temperature T2 may be corrected according to the magnitude of the friction of the internal combustion engine 1, the temperature of the oil, and the pressure of the oil.

Here, the friction of the internal combustion engine 1 can be calculated by using, as parameters, the amount of intake air, the amount of fuel injection, the number of engine revolutions per unit time, the temperature of the oil, the pressure of the oil, and so on. Moreover, an arithmetic model for calculating the friction of the internal combustion engine 1 may have been obtained beforehand by an adaptation operation using experiments, etc., and the friction of the internal combustion engine 1 may be obtained by making use of the arithmetic model thus obtained.

When the necessity of heating of the oil is determined, or when the correction of the predetermined temperature T2 is carried out, according to such a method, it is possible to raise the temperature of the oil to a temperature range suitable for the property of the oil at an early period of time. As a result, it becomes possible to avoid a situation where the heating of the oil is carried out excessively or insufficiently.

### DESCRIPTION OF THE REFERENCE NUMERALS AND SYMBOLS

1 internal combustion engine
2 oil storage tank
3 oil pump
4 oil filter
5 oil cooler
6 alternator
7 ECU
8 oil temperature sensor
9 water temperature sensor
10 accelerator position sensor
11 oil heater
12 bypass passage
13 changeover valve
14 battery
50 heat exchanger
51 flow rate regulating valve

1. A lubrication system of an internal combustion engine comprising:
an internal combustion engine through which lubricating oil circulates;
a generator that is capable of carrying out heat exchange with the lubricating oil in said internal combustion engine; and
control means that raises the temperature of the lubricating oil by means of heat produced by said generator and supplies the lubricating oil thus raised in temperature to said internal combustion engine, wherein said control means decreases an amount of the lubricating oil to be heat exchanged with said generator in a period of time in which the temperature of said generator becomes lower than the temperature of the lubricating oil.

2. The lubrication system of an internal combustion engine according to claim 1, wherein said control means makes an amount of electric power generated by said generator larger when the temperature of the lubricating oil is low, than when it is high.

3. (canceled)

4. The lubrication system of an internal combustion engine according to claim 1, wherein said period of time is a period of time from the time of start-up of the internal combustion engine until a predetermined time elapses.

5. The lubrication system of an internal combustion engine according to claim 1, further comprising:
a bypass passage to cause the lubricating oil to flow through while bypassing said alternator; and
a flow rate regulating mechanism to change an amount of the lubricating oil which passes by way of said generator, and an amount of the lubricating oil which flows through said bypass passage;
wherein said control means decreases an amount of the lubricating oil to be heat exchanged with said generator by controlling said flow rate regulating mechanism.

6. The lubrication system of an internal combustion engine according to claim 2, wherein said control means increases the amount of electric power generated by said generator under the condition that the temperature of the lubricating oil is lower than a target temperature which has been set beforehand.

7. The lubrication system of an internal combustion engine according to claim 2, wherein said control means stops increasing the amount of electric power generated by said generator when a load of said internal combustion engine becomes higher than a reference load which has been set beforehand.

8. The lubrication system of an internal combustion engine according to claim 2, wherein said control means stops increasing the amount of electric power generated by said generator in cases where the amount of electric power generated by said generator becomes larger than an allowable amount of electric power to be supplied to an electric circuit to which electric power is supplied from said generator.

9. The lubrication system of an internal combustion engine according to claim 2, further comprising:
a heater to heat the lubricating oil with electrical energy;
wherein said control means operates said heater by using the electric power produced by said generator.

10. The lubrication system of an internal combustion engine according to claim 5, further comprising:
a heater that is arranged in said bypass passage to heat the lubricating oil with electrical energy;
wherein said control means operates said heater at the time of decreasing the amount of lubricating oil to be heat exchanged with said generator.

11. The lubrication system of an internal combustion engine according to claim 2, wherein said period of time is a period of time from the time of start-up of the internal combustion engine until a predetermined time elapses.

12. The lubrication system of an internal combustion engine according to claim 2, further comprising:
a bypass passage to cause the lubricating oil to flow through while bypassing said alternator; and
a flow rate regulating mechanism to change an amount of the lubricating oil which passes by way of said generator, and an amount of the lubricating oil which flows through said bypass passage;
wherein said control means decreases an amount of the lubricating oil to be heat exchanged with said generator by controlling said flow rate regulating mechanism.

13. The lubrication system of an internal combustion engine according to claim 4, further comprising:
a bypass passage to cause the lubricating oil to flow through while bypassing said alternator; and
a flow rate regulating mechanism to change an amount of the lubricating oil which passes by way of said generator, and an amount of the lubricating oil which flows through said bypass passage;
wherein said control means decreases an amount of the lubricating oil to be heat exchanged with said generator by controlling said flow rate regulating mechanism.

14. The lubrication system of an internal combustion engine according to claim 11, further comprising:
a bypass passage to cause the lubricating oil to flow through while bypassing said alternator; and
a flow rate regulating mechanism to change an amount of the lubricating oil which passes by way of said generator, and an amount of the lubricating oil which flows through said bypass passage;
wherein said control means decreases an amount of the lubricating oil to be heat exchanged with said generator by controlling said flow rate regulating mechanism.

15. The lubrication system of an internal combustion engine according to claim 12, further comprising:
a heater that is arranged in said bypass passage to heat the lubricating oil with electrical energy;
wherein said control means operates said heater at the time of decreasing the amount of lubricating oil to be heat exchanged with said generator.

16. The lubrication system of an internal combustion engine according to claim 13, further comprising:
a heater that is arranged in said bypass passage to heat the lubricating oil with electrical energy;
wherein said control means operates said heater at the time of decreasing the amount of lubricating oil to be heat exchanged with said generator.

17. The lubrication system of an internal combustion engine according to claim 14, further comprising:
a heater that is arranged in said bypass passage to heat the lubricating oil with electrical energy;
wherein said control means operates said heater at the time of decreasing the amount of lubricating oil to be heat exchanged with said generator.
